(19) United States
(12) Patent Application Publication
(10) Pub. No.: US 2012/0066476 A1
(43) Pub. Date: Mar. 15, 2012

(54) MICRO-OPERATION PROCESSING SYSTEM AND DATA WRITING METHOD THEREOF

(75) Inventor: Cheng Tang CHENG, Hsinchu City (TW)

(73) Assignee: RDC SEMICONDUCTOR CO., LTD., Hsinchu City (TW)

(21) Appl. No.: 13/177,801

(22) Filed: Jul. 7, 2011

(30) Foreign Application Priority Data
Sep. 9, 2010 (TW) 099130505

(51) Int. Cl. G06F 15/76; G06F 9/22

(52) U.S. Cl. 712/42; 712/E09.004

(57) ABSTRACT

A data writing method and a micro-operation processing system are provided. The micro-operation processing system is adapted to access a plurality of registers and each of the registers defines at least one logic storing area. The data writing method comprises the following steps: executing a first micro-operation; selecting a target area of the first micro-operation, which has been updated by the second micro-operation before, as one of the logic storing areas; assigning each of the first micro-operation and the second micro-operation a respective identification number; determining that a execution order of the first micro-operation is later than a execution order of the second micro-operation according to the identification numbers of the first micro-operation and the second micro-operation; and recording that the target area has been updated by the first micro-operation.

This application claims priority to Taiwan Patent Application No. 099130505 filed on Sep. 9, 2010, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a micro-operation processing system and a data writing method thereof; more particularly, the present invention relates to a micro-operation processing system and a data writing method thereof capable of preventing the write-after-write data hazard.

2. Descriptions of the Related Art

In the prior art, a pipe line design has been developed to improve the effectiveness of data processing in central processing units (CPUs). The basic principle of the pipe line design is to divide the actions of a CPU into five portions: fetching a basic instruction, decoding the basic instruction into a micro-instruction, fetching operands, executing the micro-instruction and writing back the execution result. With this design, after the execution of the first action for the basic instruction is completed and when the second action is to be executed for the basic instruction, the first action may be executed for the next basic instruction synchronously. In this way, the time delay caused by the fact that the basic instruction can only be executed when the execution of a previous basic instruction has been fully completed in the conventional CPUs can be avoided.

With the advancement of the pipe line design, besides the original scheme of the sequential execution of basic instructions, CPUs capable of out-of-order execution have been further developed. The primary feature of a CPU capable of out-of-order execution is that after the basic instruction is decoded into a plurality of micro-operations, it is unnecessary for the CPU to sequentially execute the micro-operations; rather, it is only necessary to record the overall execution process of the micro-operations in a re-order buffer and when the results of the micro-operations are to be written back into the registers, the write-back sequence of the results are reordered according to the record of the execution process to ensure correctness of the data. Thus, the CPU capable of out-of-order execution can assign tasks more flexibly to further increase the execution efficiency of the CPU.

However, for the CPU capable of out-of-order execution to be successful, proper operation of the re-order buffer must be ensured to avoid the so-called write-after-write data hazard. In other words, the CPU capable of out-of-order execution must ensure that when the execution of the micro-operations is distributed in the pipe line, no error should occur in subsequently writing data back into the registers. Hence, for the CPU capable of out-of-order execution, great attention must be paid to the design and arrangement of circuits thereof, and in the case of data error, all instructions in the pipe line would have to be cleared for re-processing and might cause problems in subsequent processing stages.

To further improve the execution efficiency of the CPU, the complexity of the out-of-order execution has been increased accordingly. As a consequence, the complexity of the circuit design has increased in geometric progression, and has become impossible to ensure the proportional increase in effectively because more time is spent by the CPU in coordinating write-back actions of micro-instructions.

In view of this, an urgent need exists in the art to provide a solution that can provide a more simple circuit design for out-of-order execution without compromising the correctness and effectiveness of data processing.

### SUMMARY OF THE INVENTION

An objective of the present invention is to provide a micro-operation processing system, which comprises a plurality of registers, a processor and a control module. Each of the registers defines at least one logic storing area. The processor is configured to execute a first micro-operation. A target area of the first micro-operation is one of the logic storing areas. The target area has been updated by a second micro-operation before, and each of the first micro-operation and the second micro-operation has an identification number. The control module is configured to determine that an execution order of the first micro-operation is later than a execution order of the second micro-operation according to the identification numbers of the first micro-operation and the second micro-operation. After the processor executes the first micro-operation, the control module records what the target area is updated by the first micro-operation.

Another objective of the present invention is to provide a data writing method for a micro-operation processing system. The micro-operation processing system is adapted to access a plurality of registers, and each of the registers defines at least one logic storing area. The data writing method comprises the following steps: (a) executing a first micro-operation, a target area of the first micro-operation being one of the logic storing area, the target area having been updated by a second micro-operation before, and each of the first micro-operation and the second micro-operation having a identification number; (b) determining that an execution order of the first micro-operation is later than an execution order of the second micro-operation according to the identification numbers of the first micro-operation and the second micro-operation; and (c) recording that the target area is updated by the first micro-operation.

Yet a further objective of the present invention is to provide a micro-operation processing system, which comprises a plurality of registers, a processor and a control module. Each of the registers defines at least one logic storing area. The processor is configured to execute a micro-operation. A target area of the micro-operation is one of the logic storing areas. The control module is configured to determine that the target area of the micro-operation has not been updated. The control module is further configured to record the updated target area by the micro-operation after the processor executes the micro-operation.

Yet a further objective of the present invention is to provide a data writing method for a micro-operation processing system. The micro-operation processing system is adapted to access a plurality of registers, and each of the registers defines at least one logic storing area. The method comprises the following steps: (a) executing a micro-operation, a target area of the micro-operation being one of the logic storing areas; (b) determining that the target area of the micro-operation has not been updated; and (c) recording that the target area is updated by the micro-operation.

Based on the sequence relationship among micro-operations, the micro-operation processing system and the data writing method thereof of the present invention can ensure that no write-after-write error will occur in data writing. Furthermore, because the present invention eliminates the need of a re-order buffer, the circuit complexity of the CPU capable of out-of-order execution is decreased significantly while the effective and proper operation of the CPU can still be ensured.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a micro-operation processing system according to a first embodiment of the present invention;

FIG. 1B is a schematic view of an extended AX of the first embodiment of the present invention;

FIG. 1C is a schematic view of an updated record of the first embodiment of the present invention;

FIG. 2A is a schematic view illustrating the execution of a first micro-operation of the first embodiment of the present invention;

FIG. 2B is a schematic view illustrating the execution of a second micro-operation of the first embodiment of the present invention;

FIG. 2C is a schematic view illustrating the execution of a third micro-operation of the first embodiment of the present invention;

FIG. 3A is a schematic view of a micro-operation processing system of a second embodiment of the present invention;

FIG. 3B is a schematic view of a flag register of the second embodiment of the present invention;

FIG. 3C is a schematic view of an updated record of the second embodiment of the present invention;

FIG. 4A is a schematic view illustrating the execution of a first micro-operation of the second embodiment of the present invention;

FIG. 4B is a schematic view illustrating the execution of a second micro-operation of the second embodiment of the present invention;

FIG. 4C is a schematic view illustrating the execution of a third micro-operation of the second embodiment of the present invention; and

FIGS. 5A-5B are flowcharts of a third embodiment of the present invention.

### DESCRIPTION OF THE PREFERRED EMBODIMENT

In the following description, the present invention will be explained with reference to embodiments thereof. However, the description of these embodiments is only for the purpose of illustration rather than to limit the present invention. It should be appreciated that in the following embodiments and the attached drawings, elements not directly related to the present invention are omitted from depiction; and dimensional relationships among the individual elements in the attached drawings are illustrated only for the ease of understanding but not to limit the actual scale.

For ease of understanding, in the following embodiments and descriptions, a CPU of the 80x86 series manufactured by Intel Corporation will be taken as an example. Also, for the convenience of describing the micro-operation processing system and the data writing method thereof of the present invention, it is assumed that the executing logics of all instructions are normal and, after the instructions are decomposed into micro-operations, no exception will occur during computations. As will be appreciated by those of ordinary skill in the art, registers comprised in the CPU of the 80x86 series may include general purpose registers, pointer and index registers, segment registers, flag registers or the like. For convenience of description and understanding, general purpose registers and flag registers will be taken as examples in the following embodiments; however, the present invention has no limitation on the categories of the registers and a category of the CPU.

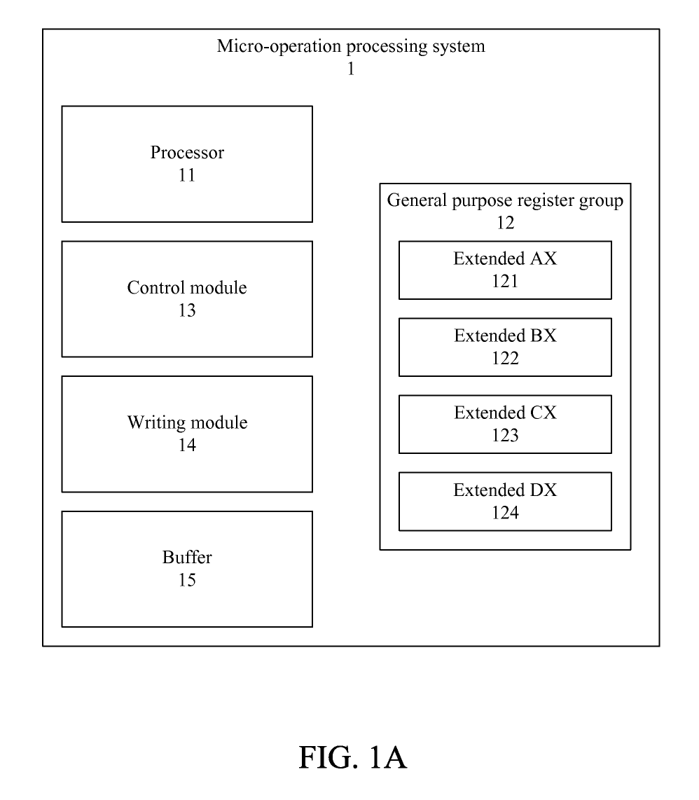

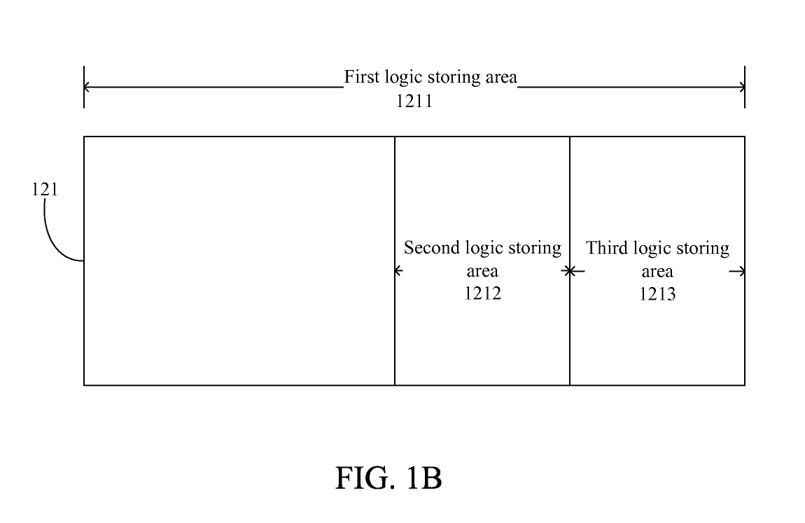

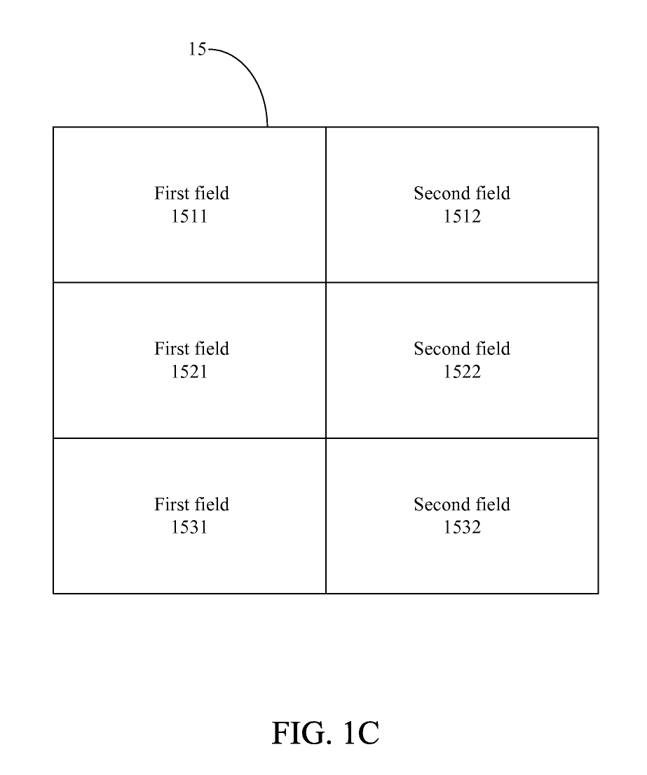

A first embodiment of the present invention is shown in FIG. 1A, FIG. 1B and FIG. 1C. FIG. 1A depicts a micro-operation processing system 1 of the first embodiment. The micro-operation processing system 1 comprises a processor 11, a general purpose register group 12, a control module 13, a writing module 14 and a buffer 15. The general purpose register group 12 comprises an extended AX (EAX) 121, an extended BX (EBX) 122, an extended CX (ECX) 123 and an extended DX (EDX) 124, each of which may be considered as a general purpose register. For purpose of clarity, the EAX 121 will be described as an example in the following descriptions and drawings; however, the technology disclosed in the present invention is not limited to be used for the EAX 121, but is also suitable for other registers of the general purpose register group 12.

In the first embodiment, each of the registers (i.e., the EAX 121, the EBX 122, the ECX 123 and the EDX 124) defines at least one logic storing area, and each of the logic storing areas has a unique storing number. For example, the EAX 121 depicted in FIG. 1B defines three logic storing areas, namely, a first logic storing area 1211, a second logic storing area 1212 and a third logic storing area 1213. Furthermore, the first logic storing area 1211, the second logic storing area 1212 and the third logic storing area 1213 may correspond to an EAX, an AH and an AL in the prior art respectively.

Next, FIG. 1C illustrates a schematic view of the buffer 15, while still referring to EAX 121 as an example. The buffer 15 stores the records of the aforesaid logic storing areas (i.e., the first logic storing area 1211, the second logic storing area 1212 and the third logic storing area 1213). Particularly, the buffer 15 has first fields 1511, 1521 and 1531, and has second fields 1512, 1522 and 1532. The first logic storing area 1211 corresponds to the first field 1511 and the second field 1512, the second logic storing area 1212 corresponds to the first field 1521 and the second field 1522, and the third logic storing area 1213 corresponds to the first field 1531 and the second field 1532. Specifically, each of the first fields 1511, 1521, 1531 is configured to record a usage status of the respective corresponding logic storing area. For example, when a first field has a value of “0”, it means that the corresponding logic storing area has not been used; otherwise, when a first field has a value of “1”, it means that the corresponding logic storing area has already been used. Each of the second fields 1512, 1522, 1532 is configured to record an identification number of a micro-operation that has updated the respective corresponding logic storing area.

It shall be particularly noted that the first logic storing area 1211, the second logic storing area 1212 and the third logic storing area 1213 correspond to the EAX, the AH and the AL respectively. As will be readily understood by those of ordinary skill in the art, when the processor 11 performs a writing operation on the AX, this represents that the writing operation is performed on the AH and the AL; and when the processor 11 performs the writing operation on the EAX, this represents that the writing operation is performed on the EAX including the AH and the AL. Hence, as the logic storing areas vary, the corresponding fields in the buffer 15 will vary accordingly. Hereinafter, a complete description will be made with reference to an example.

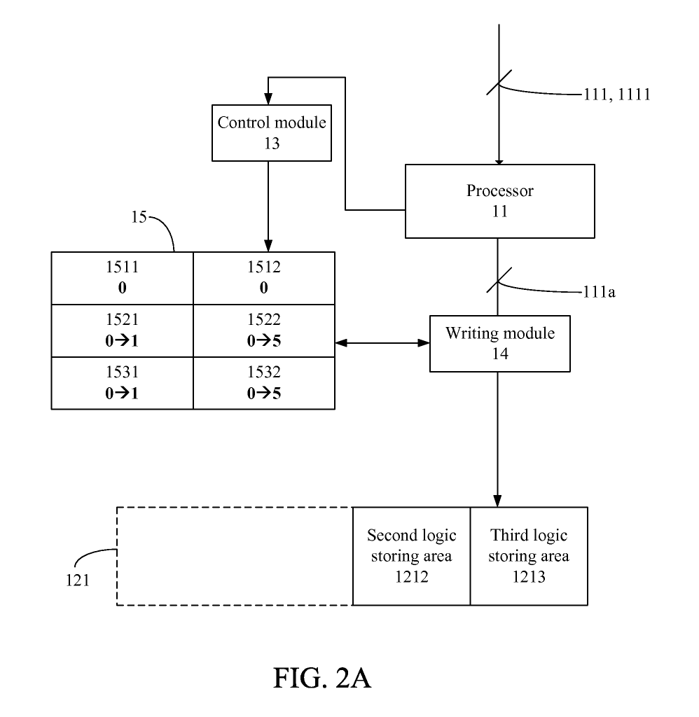

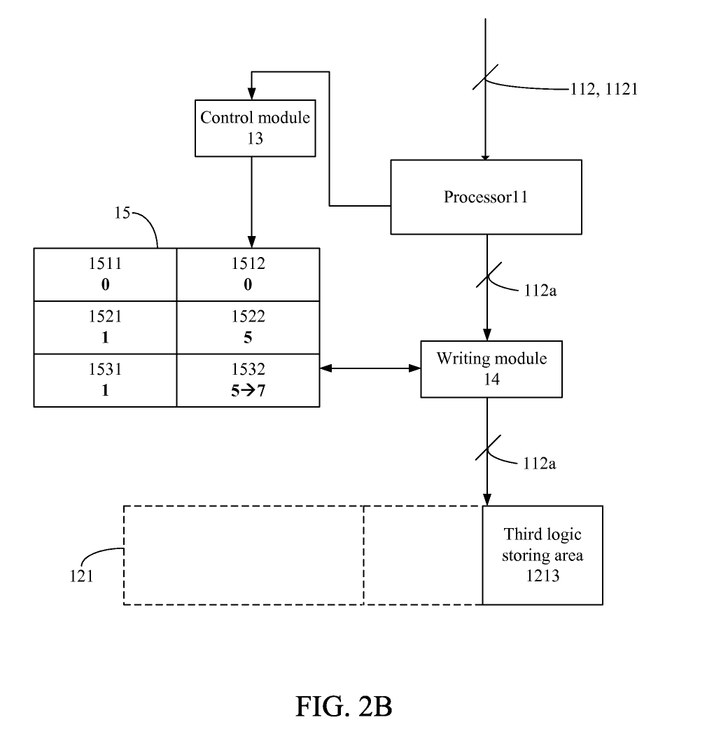

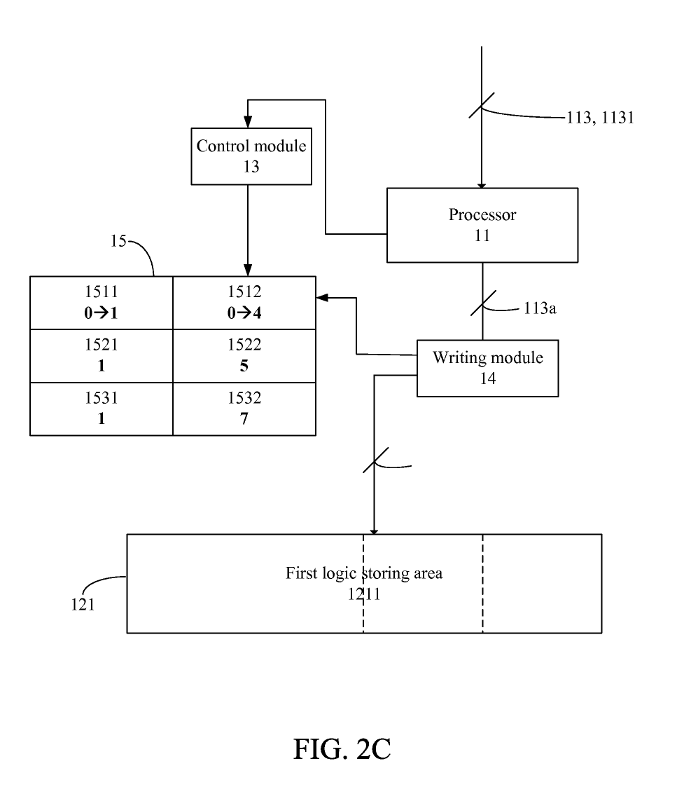

FIG. 2A illustrates a process in which the micro-operation processing system 1 processes a first micro-operation 111. The first micro-operation 111 has a target area, which is at least one of the aforesaid logic storing areas and is configured to store an execution result of the first micro-operation 111. For example, the target area of the first micro-operation 111 is the second logic storing area 1212 and the third logic storing area 1213, i.e., the AX (including the AH and the AL) known in the prior art.

Firstly, before the first micro-operation 111 is executed by the processor 11, the control module 13 records a storing number (not shown) of the target area of the first micro-operation 111 in the buffer 15. Then, the first micro-operation 111 is executed by the processor 11. The first micro-operation 111 has an identification number 1111 which has a value of “5”. It shall be particularly noted that the value “5” of the identification number 1111 represents that the first micro-operation 111 has an execution order of fifth when micro-operations are executed in order.

After the first micro-operation 111 is executed by the processor 11, the writing module 14 retrieves the storing number of the target area of the first micro-operation 111 from the buffer 15. From the storing number, it is known that the target area of the first micro-operation 111 is the second logic storing area 1212 and the third logic storing area 1213 (i.e., the AX including the AH and the AL). In the buffer 15, the first field 1521 corresponding to the second logic storing area 1212 has a value of “0”, which represents that the second logic storing area 1212 has not been updated. In addition, the first field 1531 corresponding to the third logic storing area 1213 has a value of “0”, which represents that the third logic storing area 1213 has not been updated. In other words, the first fields 1521, 1531 both have a value of “0”, so the control module 13 will firstly update the values of the first fields 1521, 1531 as “1” and then record the value “5” of the identification number 1111 of the first micro-operation 111 as the second fields 1522, 1532 to record that the second logic storing area 1212 and the third logic storing area 1213 have been updated by the first micro-operation 111. Finally, an execution result 111a of the first micro-operation 111 is written by the writing module 14 into the AX (i.e., the second logic storing area 1212 and the third logic storing area 1213) of the EAX 121.

FIG. 2B illustrates the process in which the micro-operation processing system 1 processes a second micro-operation 112. The second micro-operation 112 has a target area, which is at least one of the aforesaid logic storing areas and is configured to store an execution result of the second micro-operation 112. For example, the target area of the second micro-operation 112 is the second logic storing area 1212, i.e., the AH known in the prior art.

Firstly, before the second micro-operation 112 is executed by the processor 11, the control module 13 records a storing number (not shown) of the target area of the second micro-operation 112 in the buffer 15. Then, the second micro-operation 112 is executed by the processor 11. The second micro-operation 112 has an identification number 1121 which has a value of “7”. It shall be particularly noted that the value “7” of the identification number 1121 represents that the second micro-operation 112 has an execution order of seventh when micro-operations are executed in order.

After the second micro-operation 112 is executed by the processor 11, the writing module 14 retrieves the storing number of the target area of the second micro-operation 112 from the buffer 15. From the storing number, it is known that the target area of the second micro-operation 112 is the second logic storing area 1212; i.e., it is known that the execution result of the second micro-operation 112 is to be stored in the AH. In the buffer 15, the first field 1521 corresponding to the second logic storing area 1212 has a value of “1” recorded therein, which represents that the second logic storing area 1212 has been updated. Because the second logic storing area 1212 has been updated, the control module 13 then compares the value of the second field 1522 with the value of the identification number 1121. Here, the value “5” stored in the second field 1522 is smaller than the value “7” of the identification number 1121, which represents that an execution order of the second micro-operation 112 is later than that of the first micro-operation 111 when micro-operations are executed in order. Thus, the control module 13 updates the value of the second field 1522 as the value “7” of the identification number 1121 from the value “5” of the original identification number 1111, and the writing module 14 then writes an execution result 112a of the second micro-operation 112 into the second logic storing area 1212 (i.e., the AH).

Next, FIG. 2C illustrates the process in which the micro-operation processing system 1 processes a third micro-operation 113. The third micro-operation 113 has a target area, which is at least one of the aforesaid logic storing areas and is configured to store an execution result of the third micro-operation 113. For example, the target area of the third micro-operation 113 is the first logic storing area 1211, i.e., the EAX known in the prior art.

Firstly, before the third micro-operation 113 is executed by the processor 11, the control module 13 records in the buffer 15 a storing number (not shown) of the target area of the third micro-operation 113. Then, the third micro-operation 113 is executed by the processor 11. The third micro-operation 113 has an identification number 1131 which has a value of “4”, and this represents that the third micro-operation 113 has an execution order of fourth when micro-operations are executed in order.

After the third micro-operation 113 is executed by the processor 11, the writing module 14 retrieves the storing number of the target area of the third micro-operation 113 from the buffer 15. From the storing number, it is known that the execution result of the third micro-operation 113 is to be stored in the first logic storing area 1211 (i.e., the EAX including the AH and the AL). Then, according to the content (a value of “0”) recorded in the first field 1511 of the buffer 15 that corresponds to the first logic storing area 1211, it is known that the first logic storing area 1211 has not been updated. Because the first logic storing area 1211 has not been updated, the control module 13 will firstly update the value of the first field 1511 as “1” and then record the value of the identification number 1131 of the third micro-operation 113 into the second field 1512. Then, the writing module 14 writes an execution result 113a of the third micro-operation 113 into the front end of the first logic storing area 1211 (i.e., the EAX). The writing action to the first logic storing area 1211 causes the writing actions to the second logic storing area (i.e., the AH) 1212 and the third logic storing area (i.e., the AL) 1213 at the back end. Hence, the control module 13 needs to determine whether the value of the second field 1522 corresponding to the second logic storing area 1212 is larger than the value of the identification number 1131. Since the value “5” of the second field 1522 is larger than the value “4” of the identification number 1131, which represents that the execution order of the second micro-operation 112 is later than that of the third micro-operation 113, the control module 13 feeds back the execution result (not shown) of the third micro-operation 113 rather than storing it in the second logic storing area (i.e., the AH); and similarly, the same process applies for the AL.

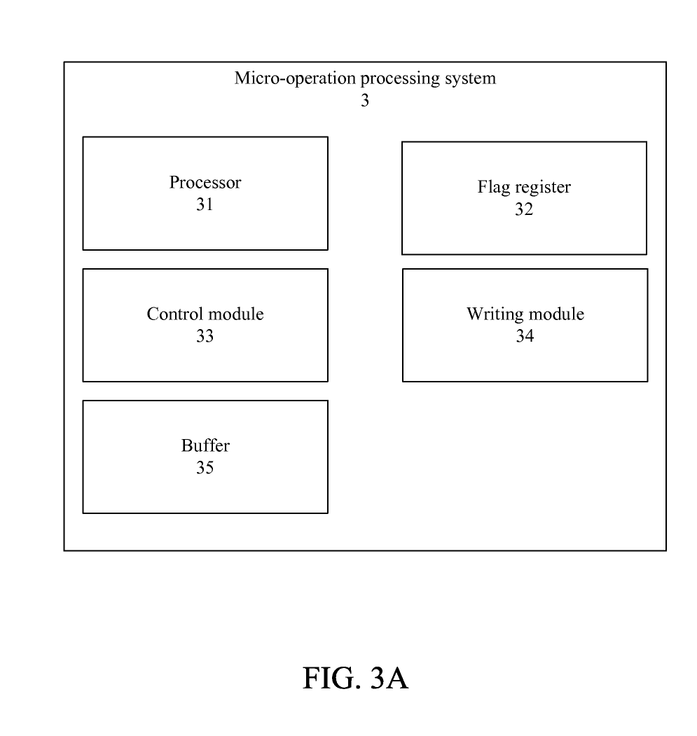

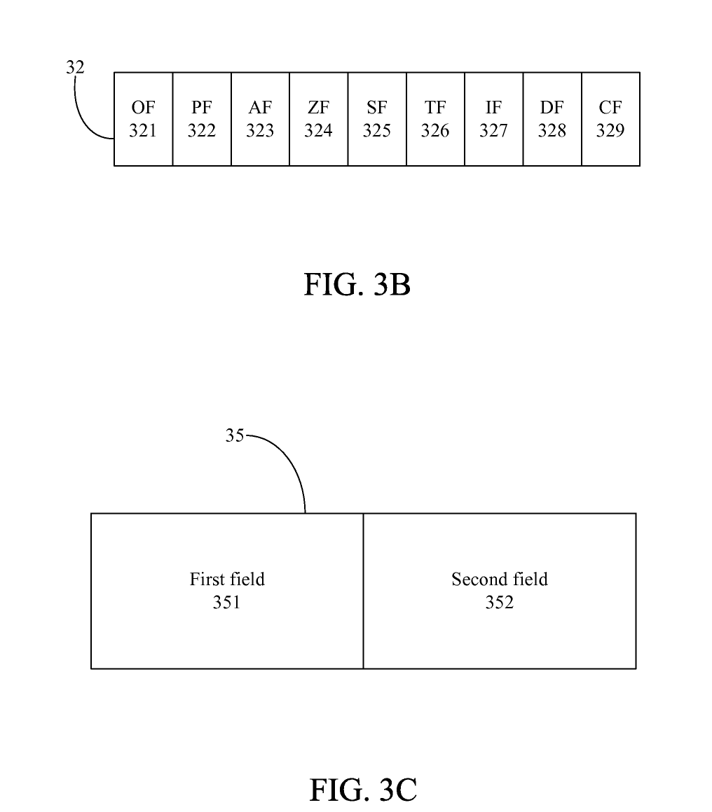

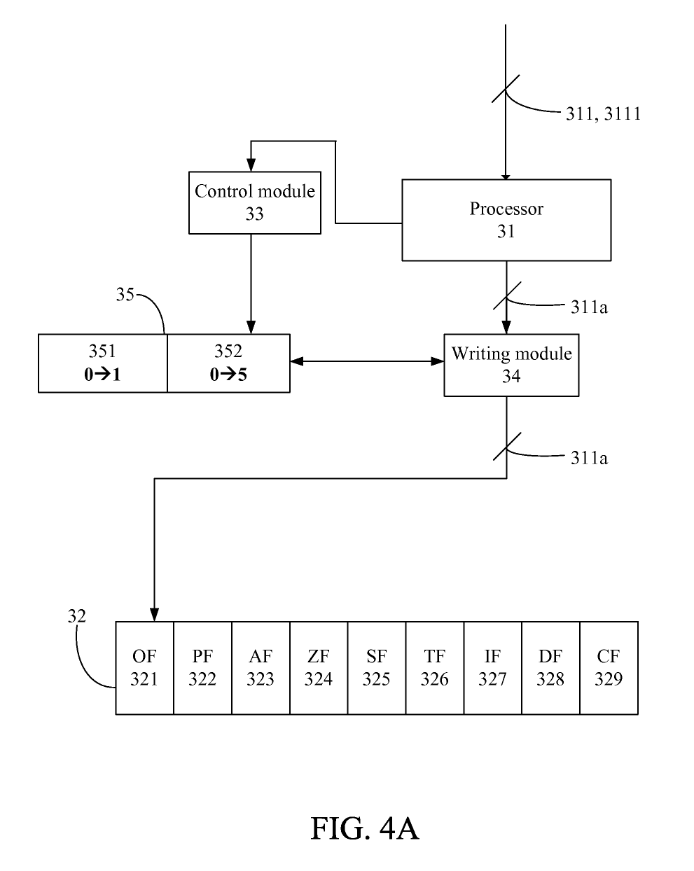

The aforesaid embodiment is described by taking the general purpose registers as an example. Hereinafter, a flag register will be taken as another example in a second embodiment of the present invention. Firstly, refer to FIG. 3A, FIG. 3B and FIG. 3C. FIG. 3A depicts a micro-operation processing system 3 of the second embodiment The micro-operation processing system 3 comprises a processor 31, a flag register 32, a control module 33, a writing module 34 and a buffer 35. Flags in the flag register 32, which may generally fall into three categories (i.e., status flags, control flags and system flags), and include nine basic flags, namely, an overflow flag (OF), a parity flag (PF), an auxiliary carry flag (AF), a zero flag (ZF), a sign flag (SF), a trap flag (TF), an interrupt flag (IF), a direction flag (DF) and a carry flag (CF). Functions of these flags will be readily understood by those of ordinary skill in the art, and thus will not be further described herein.

In the second embodiment, the flag register 32 defines at least one logic storing area, and each of the logic storing areas has a unique storing number. For example, the flag register 32 depicted in FIG. 3B defines nine logic storing areas 321-329, which correspond to the aforesaid nine basic flags respectively. For purpose of clarity, the OF in the flag register will be described as an example in the following descriptions and drawings; however, the technology disclosed in the present invention is not limited to be used for a specific flag, but is also suitable for other flags of the flag register 32. It shall be particularly noted that the logic storing area 321 corresponds to the OF in the prior art.

FIG. 3C illustrates a schematic view of the buffer 35. The buffer 35 stores a record of the logic storing area 321. In more detail, the buffer 35 has a first field 351 and a second field 352. The logic storing area 321 corresponds to the first field 351 and the second field 352.

Specifically, the first field 351 is configured to record a usage status of the logic storing area 321. For example, when the first field has a value of “0”, this means that the logic storing area 321 has not been used; otherwise, when the first field has a value of “1”, this means that the logic storing area 321 has already been used. The second field 352 is configured to record an identification number of a micro-operation that has updated the logic storing area 321.

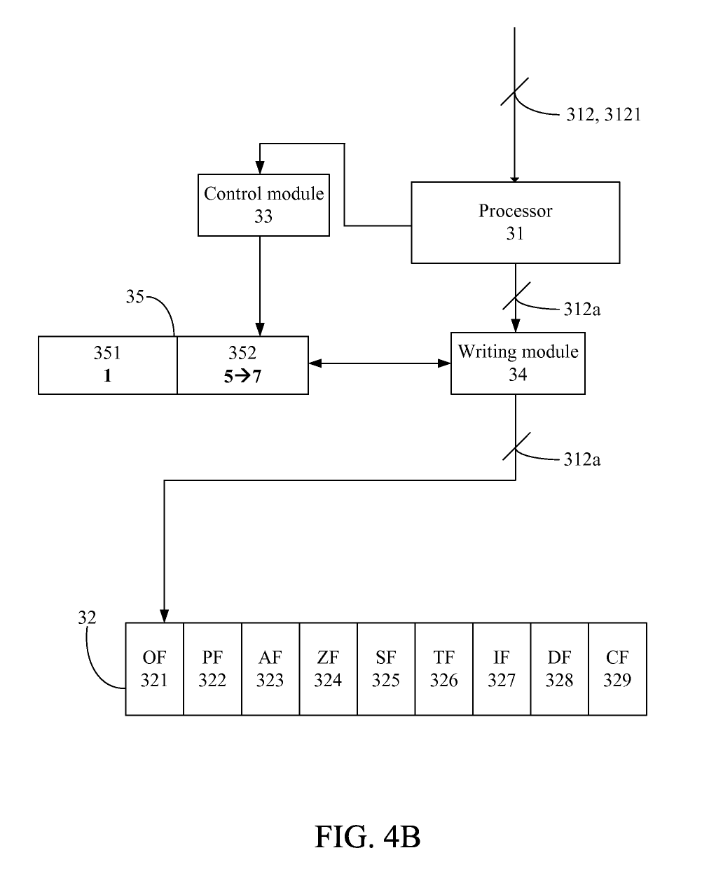

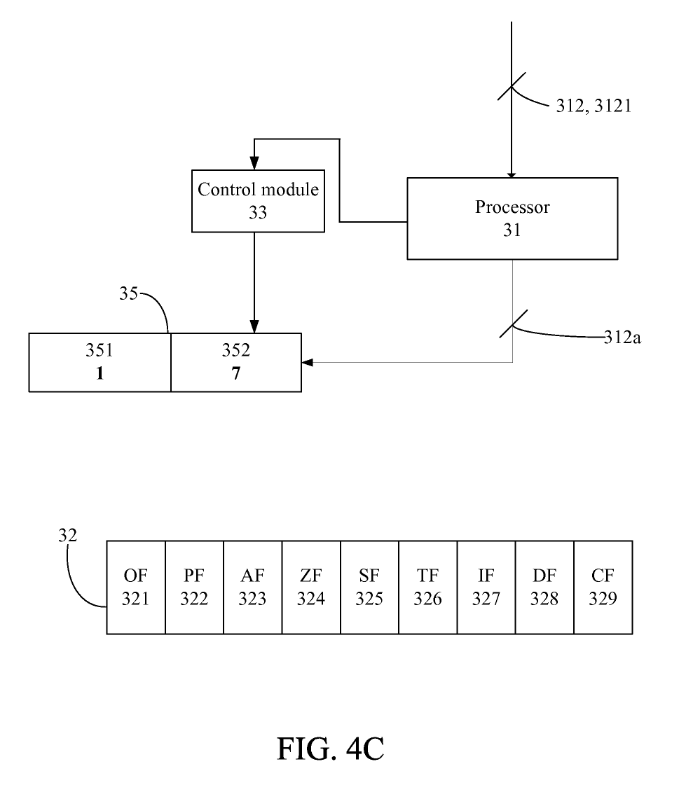

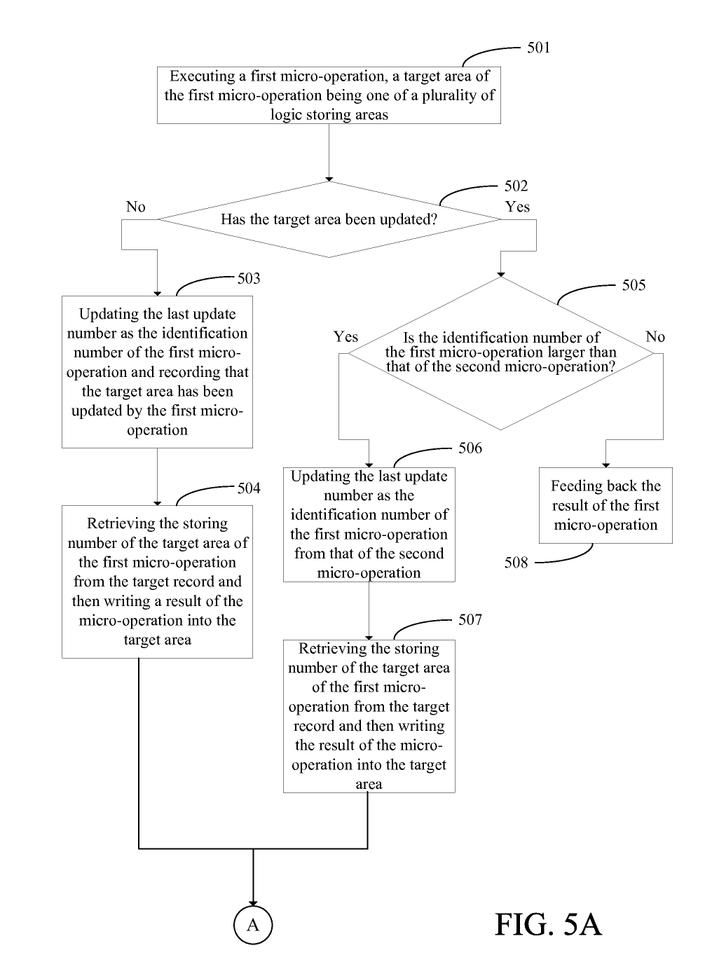

FIG. 4A illustrates a process in which the micro-operation processing system 3 processes a first micro-operation 311. The first micro-operation 311 has an identification number 3111 which has a value of “5”. It shall be particularly noted that the value of the identification number 3111 represents that the first micro-operation 311 has an execution order of fifth when micro-operations are executed in order.

If an overflow occurs after the execution of the first micro-operation 311, then a change will occur in a flag area of the flag register 32. This flag area is the logic storing area 321, and is configured to store a status caused by the execution of the first micro-operation 311. Specifically, if an overflow status is caused after the execution of the first micro-operation 311, then a flag area that experiences the change is the logic storing area 321, i.e., the OF known in the prior art.

Firstly, before the first micro-operation 311 is executed by the processor 31, the control module 33 records in the buffer 35 a storing number (not shown) of a flag area that will be changed if an overflow status 311a occurs. It shall be particularly noted that in this embodiment, the flag area that will be changed by the overflow status 311a is considered a target area.

It is assumed that the overflow status 311a occurs after the first micro-operation 311 is executed by the processor 31, and the writing module 34 then retrieves from the buffer 35 the storing number of the flag area (i.e., the target area) that is to be changed by the overflow status 311a. From the storing number, it is known that the flag area that is to be changed by the overflow status 311a is the logic storing area 321. In the buffer 35, the first field 351 corresponding to the logic storing area 321 has a value of “0”, which represents that the logic storing area 321 has not been updated. In other words, the first field 351 has a value of “0”, so the control module 33 will firstly update the value of the first field 351 as “1” and then record the value “5” of the identification number 3111 of the first micro-operation 311 into the second field 352 to record that the logic storing area 321 has been updated by the first micro-operation 311. Finally, the writing module 34 updates the value of the OF field of the flag register 32 into “1” from “0”.

FIG. 4B illustrates a process in which the micro-operation processing system 3 processes a second micro-operation 312. The second micro-operation 312 has an identification number 3121 which has a value of “7”. It shall be particularly noted that the value of the identification number 3121 represents that the second micro-operation 312 has an execution order of seventh when micro-operations are executed in order.

Firstly, before the second micro-operation 312 is executed by the processor 31, the control module 33 records in the buffer 35 a storing number (not shown) of a flag area that will be changed if an overflow status 312a occurs. It shall be particularly noted that in this embodiment, the flag area that will be changed by the overflow status 312a is considered as a target area.

It is assumed that the overflow status 312a occurs after the second micro-operation 312 is executed by the processor 31, and the writing module 34 then retrieves from the buffer 35 the storing number of the flag area (i.e., the target area) that is to be changed by the overflow status 312a. From the storing number, it is known that the flag area that is to be changed by the overflow status 312a is the logic storing area 321. In the buffer 35, the first field 351 corresponding to the logic storing area 321 has a value of “1”, which represents that the logic storing area 321 has been updated. Because the logic storing area 321 has been updated, the control module 33 then compares the value of the second field 352 with the value of the identification number 3121. Here, the value “5” stored in the second field 352 is smaller than the value “7” of the identification number 3121, which represents that the execution order of the second micro-operation 312 is later than that of the first micro-operation 311 when micro-operations are executed in order. Thus, the control module 33 updates the value of the second field 352 into the value “7” of the identification number 3121 from the value “5” of the original identification number 3111, and the writing module 34 then writes the overflow status 312a into the logic storing area 321.

FIG. 4C illustrates a process in which the micro-operation processing system 3 processes a third micro-operation 313. The third micro-operation 313 has an identification number 3131 which has a value of “4”. It shall be particularly noted that the value of the identification number 3131 represents that the third micro-operation 313 has an execution order of fourth when micro-operations are executed in order. Firstly, before the third micro-operation 313 is executed by the processor 31, the control module 33 records in the buffer 35 a storing number (not shown) of a flag area that will be changed if an overflow status 313a occurs.

It is assumed that the overflow status 313a occurs after the third micro-operation 313 is executed by the processor 31, and the writing module 34 then retrieves from the buffer 35 the storing number of the flag area (i.e., the target area) that is to be changed by the overflow status 313a. From the storing number, it is known that the flag area that is to be changed by the overflow status 313a is the logic storing area 321. In the buffer 35, the first field 351 corresponding to the logic storing area 321 has a value of “1”, which represents that the logic storing area 321 has been updated. Because the logic storing area 321 has been updated, the control module 33 then compares the value of the second field 352 with the value of the identification number 3131. The value “7” stored in the second field 352 is larger than the value “4” of the identification number 3131, which represents that the execution order of the third micro-operation 313 is earlier than that of the second micro-operation 312 when micro-operations are executed in order. Thus, the control module 33 feeds back the overflow status 313a (not shown) rather than storing it in the logic storing area 321.

It shall be particularly emphasized that in order to prevent related information of a micro-operation from still affecting the operation of the entire micro-operation processing system after the execution of the micro-operation retires, related data of the micro-operation in the buffer will be cleared once execution of the micro-operation is confirmed to be completed. Specifically, taking the result of the first embodiment as an example, if no other micro-operation is executed, then the labeling data of the first micro-operation 111 will still exist in the buffer 15 (the value “1” of the first field 1521 and the value “5” of the second field 1522) when the execution of the first micro-operation 111 retires. In this case, if the data retained in the first field 1521 and the second field 1522 fail to be cleared after execution of the first micro-operation 111 retires, then subsequent micro-operations to be executed will likely be affected.

Therefore, in view of this, when the execution of the first micro-operation 111 retires, the control module 13 of the micro-operation processing system 1 will firstly determine whether the buffer 15 has a logic storing area in which the first field has a value of “1” and a value of the corresponding second field is the identification number (the value “5”) of the first micro-operation 111. In other words, the control module 13 firstly determines whether the labeling data of the first micro-operation 111 are still recorded in the buffer 15. Then, the control module 13 determines that the value of the first field 1521 is “1” and the value of the second field 1522 is “5”, which represents that the labeling data of the first micro-operation 111 are still recorded in the buffer 15. Therefore, the control module 13 will clear data of the first field 1521 and the second field 1522 in the buffer 15 simultaneously when the execution of the first micro-operation 111 retires, and reset the value “1” of the first field 1521 to be a default number (the value “0”) so that the second logic area 1212 represented by the first field 1511 and the second field 1522 can be directly used subsequently. In this way, the subsequent operation of the micro-operation processing system 1 will not be affected by the micro-operation that has already been completed. Similarly, in the second embodiment, the micro-operation processing system 3 may also operate in the aforesaid way; this can be readily appreciated by people skilled in the art and, thus, will not be further described herein.

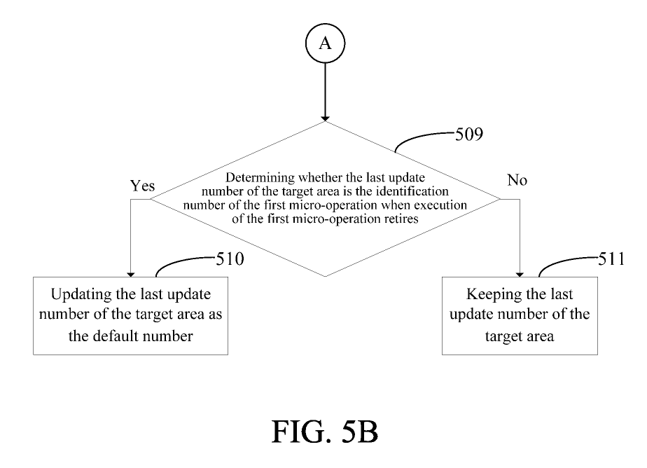

FIGS. 5A and 5B illustrates a flowchart according to a third embodiment of the present invention. The third embodiment is a data writing method for a micro-operation processing system. The micro-operation processing system is adapted to access a plurality of registers. Each of the registers defines at least one logic storing area. Each of the logic storing areas has a storing number, and the data writing method is used with an updated record and a target record. The micro-operation processing system may be either of the micro-operation processing systems 1, 3 described in the first embodiment and the second embodiment.

Firstly, in reference to FIG. 5A, before a first micro-operation is executed, the storing number of the target storing area of the first micro-operation is recorded in the target record. Then, the first micro-operation is executed in step 501. The first micro-operation has an identification number. A target area of the first micro-operation is one of the logic storing areas. Step 502 is executed to, according to a last update number in the update record, determine whether the target area has been updated (i.e., whether the last update number is not a default number). If the target area has not been updated, then step 503 is executed to update the last update number as the identification number of the first micro-operation and record that the target area has been updated by the first micro-operation. Then, step 504 is executed to retrieve the storing number of the target area of the first micro-operation from the target record and then write a result of the micro-operation into the target area.

If the determination result of step 502 is that the target area has been updated by a second micro-operation, which represents that the last update number is an identification number of the second micro-operation, then step 505 is executed. In step 505, it is determined whether the identification number of the first micro-operation is larger than the identification number of the second micro-operation according to the identification numbers of the first micro-operation and the second micro-operation. If the identification number of the first micro-operation is larger than the identification number of the second micro-operation, then step 506 is executed to update the last update number as the identification number of the first micro-operation from the identification number of the second micro-operation and record that the target area has been updated by the first micro-operation. Then, step 507 is executed to retrieve the storing number of the target area of the first micro-operation from the target record and then write the result of the micro-operation into the target area. However, if the determination result of the step 505 is that the identification number of the first micro-operation is smaller than the identification number of the second micro-operation, then step 508 is executed to feed back the result of the first micro-operation.

It shall be appreciated that the basis on which the execution orders of the first micro-operation and the second micro-operation are determined is not limited to the identification numbers, i.e., a later execution order may be represented by either a larger identification number or a smaller identification number; furthermore, one of the registers may be either a general purpose register or a flag register. Similarly, in the third embodiment, in order to prevent related information of a micro-operation from still affecting operation of the entire micro-operation processing system when the execution of the micro-operation retires, data of the update record will be reset if related labeling data of the micro-operation still exist in the update record when the micro-operation execution is confirmed to be completed. In other words, this allows the target area to be directly used subsequently. In this way, the micro-operation processing system will not be affected by the micro-operation that has already been completed to ensure correctness of subsequent operations. In detail, in reference to FIG. 5B, after step 504 and the step 507 are executed and when the execution of the first micro-operation retires, step 509 is executed to determine whether the last update number of the target area is the identification number of the first micro-operation. If the determination result is “yes”, this represents that the labeling data of the first micro-operation still exists in the update record, and then step 510 is executed to update the last update number of the target area as the default number so that the target area can be used for subsequent micro-operations; otherwise, if the determination result is “no”, this represents that the labeling data of the first micro-operation do not exist in the update record, and then step 511 is executed to keep the last update number of the target area.

According to the above descriptions, the present invention is suitable for use in processors capable of out-of-order execution, and can obviate data problems caused by the write-after-write data hazard without the need of a re-order buffer. Thus, the bottleneck in terms of the execution speed that might be caused by an excessively complex circuit design can be avoided in the processors.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A data writing method for a micro-operation processing system, the micro-operation processing system being adapted to access a plurality of registers, each of the registers defining at least one logic storing area, the data writing method comprising the following steps of:
(a) executing a first micro-operation, a target area of the first micro-operation being one of the logic storing areas, the target area having been updated by a second micro-operation before, and each of the first micro-operation and the second micro-operation having an identification number;
(b) determining that an execution order of the first micro-operation is later than an execution order of the second micro-operation according to the identification numbers of the first micro-operation and the second micro-operation; and
(c) recording that the target area is updated by the first micro-operation.

2. The data writing method as claimed in claim 1, further comprising the following step of:
(d) writing an execution result of the first micro-operation in the target area.

3. The data writing method as claimed in claim 1, wherein the data writing method is used with an update record, the update record stores a last update number of the target area, the last update number is the identification number of the second micro-operation, in the step (b), the identification number of the first micro-operation is compared with the last update number of the target area to determine that the execution order of the first micro-operation is later than the execution order of the second micro-operation, and in the step (c), the last update number of the target area, which is recorded in the update record, is updated as the identification number of the first micro-operation.

4. The data writing method as claimed in claim 3, further comprising the following steps of:
(d) determining that the last update number of the target area is the identification number of the first micro-operation while the first micro-operation retires; and
(e) updating the last update number of the target area as a default number according to the result of the step (d).

5. The data writing method as claimed in claim 3, wherein the identification number of the second micro-operation is larger than the identification number of the first micro-operation, and in the step (b), the execution order of the first micro-operation being later than the execution order of the second micro-operation is determined according to that the identification number of the second micro-operation is larger than the identification number of the first micro-operation.

6. The data writing method as claimed in claim 3, wherein the identification number of the second micro-operation is smaller than the identification number of the first micro-operation, and in the step (b), the execution order of the first micro-operation being later than the execution order of the second micro-operation is determined according to that the identification number of the second micro-operation is smaller than the identification number of the first micro-operation.

7. The data writing method as claimed in claim 2, wherein the data writing method is used with a target record, each of the logic storing areas has a storing number, and the data writing method further comprises the following steps of:
recording the storing number of the target area of the first micro-operation in the target record before the step (a); and
retrieving the storing number of the target area of the first micro-operation from the target record before the step (d).

8. A micro-operation processing system, comprising:
a plurality of registers, each of the registers defining at least one logic storing area;
a processor, being configured to execute a first micro-operation, a target area of the first micro-operation being one of the logic storing areas, the target area having been updated by a second micro-operation before, and each of the first micro-operation and the second micro-operation having an identification number; and
a control module, being configured to determine that an execution order of the first micro-operation is later than an execution order of the second micro-operation according to the identification numbers of the first micro-operation and the second micro-operation, and to record that the target area is updated by the first micro-operation after the processor executes the first micro-operation.

9. The micro-operation processing system as claimed in claim 8, further comprising:
a writing module, being configured to write an execution result of the first micro-operation in the target area.

10. The micro-operation processing system as claimed in claim 8, further comprising:
a buffer, being configured to store a last update number of the target area, and the last update number being the identification number of the second micro-operation;
wherein the control module is configured to compare the identification number of the first micro-operation with the last update number of the target area to determine that the execution order of the first micro-operation is later than the execution order of the second micro-operation, and the control module is further configured to update the last update number of the target area, which is stored in the buffer, as the identification number of the first micro-operation.

11. The micro-operation processing system as claimed in claim 10, wherein the control module is further configured to determine that the last update number of the target area is the identification number of the first micro-operation while execution of the first micro-operation retires, and to update the last update number of the target area as a default number.

12. The micro-operation processing system as claimed in claim 10, wherein the identification number of the second micro-operation is larger than the identification number of the first micro-operation, and the control module is further configured to determine that the execution order of the first micro-operation is later than the execution order of the second micro-operation according to that the identification number of the second micro-operation is larger than the identification number of the first micro-operation.

13. The micro-operation processing system as claimed in claim 10, wherein the identification number of the second micro-operation is smaller than the identification number of the first micro-operation, and the control module is further configured to determine that the execution order of the first micro-operation is later than the execution order of the second micro-operation according to that the identification number of the second micro-operation is smaller than the identification number of the first micro-operation.

14. The micro-operation processing system as claimed in claim 9, further comprising:
a buffer;
wherein each of the logic storing areas has a storing number, the control module is further configured to record the storing number of the target area of the first micro-operation in the buffer before the processor executes the first micro-operation, and the writing module is further configured to retrieve the storing number of the target area of the first micro-operation from the buffer before writing the execution result of the first micro-operation in the target area.

15. The micro-operation processing system as claimed in claim 8, wherein one of the registers is a general purpose register.

16. The micro-operation processing system as claimed in claim 8, wherein one of the registers is a flag register.

17. A data writing method for a micro-operation processing system, the micro-operation processing system being adapted to access a plurality of registers, each of the registers defining at least one logic storing area, the method comprising the following steps of:
(a) executing a micro-operation, a target area of the micro-operation being one of the logic storing areas;
(b) determining that the target area of the micro-operation has not been updated; and
(c) recording that the target area is updated by the micro-operation.

18. The data writing method as claimed in claim 17, further comprising the following step of:
(d) writing an execution result of the micro-operation in the target area.

19. The data writing method as claimed in claim 17, wherein the data writing method is used with an update record, the update record stores a last update number of the target area, the last update number is a default number, in the step (b), the target area having not been updated is determined according to the default number, and in the step (c), the last update number of the target area is updated as an identification number of the micro-operation.

20. The data writing method as claimed in claim 19, further comprising the following steps of:
(d) determining that the last update number of the target area is the identification number of the first micro-operation while execution of the first micro-operation retires; and
(e) updating the last update number of the target area as the default number according to the result of the step (d).

21. The data writing method as claimed in claim 18, wherein the data writing method is used with a target record, each of the logic storing areas has a storing number, and the data writing method further comprises the following steps of:
recording the storing number of the target area of the micro-operation in the target record before the step (a); and
retrieving the storing number of the target area of the micro-operation from the target record before the step (b).

22. A micro-operation processing system, comprising:
a plurality of registers, each of the registers defining at least one logic storing area;
a processor, being configured to execute a micro-operation, a target area of the micro-operation being one of the logic storing areas; and
a control module, being configured to determine that the target area of the micro-operation has not been updated, and to record that the target area is updated by the micro-operation after the processor executes the micro-operation.

23. The micro-operation processing system as claimed in claim 22, further comprising:
a writing module, being configured to write an execution result of the micro-operation in the target area.

24. The micro-operation processing system as claimed in claim 22, further comprising:
a buffer, being configured to store a last update number of the target area, and the last update number being a default number;
wherein the control module is configured to determine that the target area has not been updated according to the default number, and to update the last update number of the target area as an identification number of the micro-operation.

25. The micro-operation processing system as claimed in claim 23, further comprising:
a buffer;
wherein each of the logic storing areas has a storing number, the control module is further configured to record the storing number of the target area of the micro-operation in the buffer before the processor executes the micro-operation, and the writing module is further configured to retrieve the storing number of the target area of the micro-operation from the buffer before writing the execution result of the micro-operation in the target area.

26. The micro-operation processing system as claimed in claim 25, wherein the control module is further configured to determine that the last update number of the target area is the identification number of the micro-operation while execution of the micro-operation retires, and to update the last update number of the target area as the default number.

27. The micro-operation processing system as claimed in claim 22, wherein one of the registers is a general purpose register.

28. The micro-operation processing system as claimed in claim 22, wherein one of the registers is a flag register.
